(19) United States
(12) Patent Application Publication
(10) Pub. No.: US 2008/0107925 A1
(43) Pub. Date: May 8, 2008

(54) FUEL CELL DEVICE

(76) Inventor: WEI-JUI CHUANG, Kaohsiung (TW)

Correspondence Address: G. LINK CO., LTD., 3550 BELL ROAD, MINOOKA, IL, 60447, US

(21) Appl. No.: 11/556,572

(22) Filed: Nov. 3, 2006

(51) Int. Cl. H01M 8/02

(52) U.S. Cl. 429/12

(57) ABSTRACT

A fuel cell device includes a fuel cell main body, a balance of plant and a water collecting trough. The fuel cell main body is employed to generate power. The balance of plant is connected to the fuel cell main body. The water collecting trough is disposed under the fuel cell main body and the balance of plant for collecting flooded water of the fuel cell main body and the balance of plant. Hence, problems resulted from water flooding can be overcome effectively.

### BACKGROUND OF THE INVENTION

1. Field of the Invention

The present invention is related to a fuel cell device and particularly to a fuel cell device capable of treating phenomenon of water flooding occurring therein.

2. Brief Description of the Related Art

It is known that a fuel cell device is a power generating device to convert chemical energy in a fuel and oxide agent to electrical energy directly by means of electrical pole reaction. Currently, there are a lot of different types of fuel cells and they can be classified based on different electrolytes as basic fuel cell, phosphoric acid fuel cell, proton exchange film fuel cell, molten carbonic acid fuel cell and solid state oxide fuel cell. Although fuel cell technology has some progresses in the recent years, a commercialized fuel cell still faces tremendous technical challenges such as low gross efficiency and power density, water control, heat control, miniaturization and cost.

Most fuel cells produce water after electrochemical reaction is performed and how to treat water production always is an important subject has to be overcome in fuel cell system design. Problems related to guiding and recycling the produced water have to be solved properly before the fuel cell can be commercialized.

Especially, phenomenon of water flooding frequently occurs during the fuel cell processing electrochemical reaction and it is a problem has to be overcome urgently. There are many reasons to cause the water flooding. One of the reasons is possibly caused by an ambient environment condition such as temperature or ventilation. Another one of the reasons is possibly caused by the water produced by electrochemical reaction of the fuel cell. However, the phenomenon of water flooding is neglected by the prior art and the flooded water is not treated well such that the flooded water stays in the air passage to hinder oxygen supply to the fuel cell and power generation efficiency is affected substantively. Further, the flooded water may overflow to circuit of the electronic product attached to fuel cell due to improper system management of the conventional fuel cell and it unfavorably results in the electronic product being out of order or short circuit.

### SUMMARY OF THE INVENTION

Accordingly, an object of the present invention is to provide a fuel cell device which is capable of dealing with phenomenon and avoiding the preceding problems encountered by the conventional fuel cell device.

In order to achieve the preceding object, a fuel cell device according to the present invention includes a fuel cell main body, which generates power, balance of plant, which connects with the fuel cell main body, and a water collecting trough, which is disposed under the fuel cell main body and the peripheral equipment for collecting flooded water of the main fuel cell member and the balance of plant.

### BRIEF DESCRIPTION OF THE DRAWINGS

The detail structure, the applied principle, the function and the effectiveness of the present invention can be more fully understood with reference to the following description and accompanying drawings, in which:

FIG. 1 is perspective view illustrating a fuel cell device according to the present invention; and

FIG. 2 is a side view of the fuel cell device shown in FIG. 1.

### DETAILED DESCRIPTION OF THE INVENTION

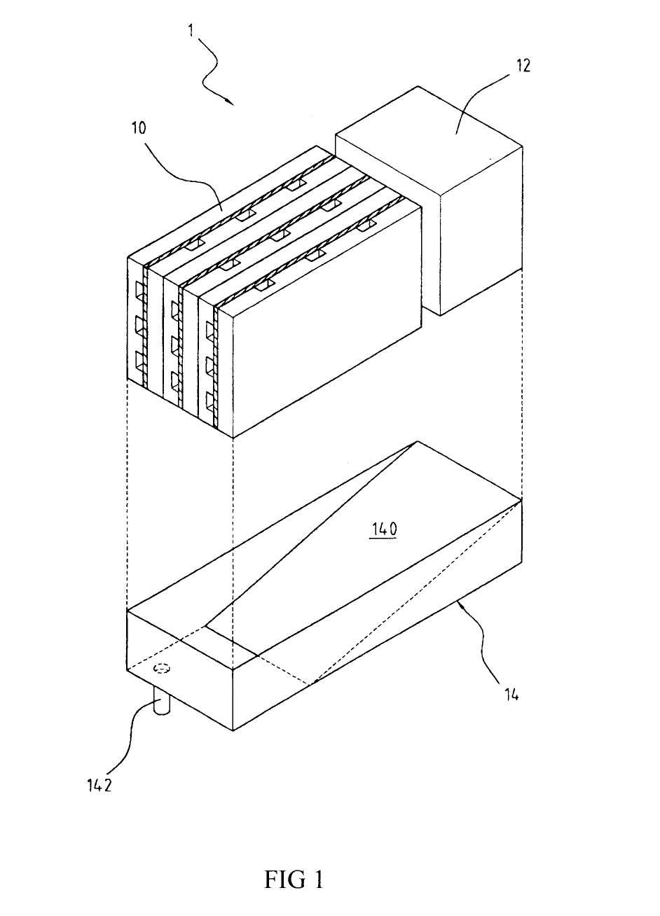

Referring to FIG. 1, a fuel cell device according to the present invention includes a fuel cell main body 10, balance of plant 12 and a water collecting trough 14. The fuel cell main body 10 is employed to produce power and composed of a fuel cell stack such as direct methanol fuel cell stack in a liquid state fuel cell. The balance of plant 12 is connected to the fuel cell main member 10. There are many components in the balance of plant 12 such as pump, condenser, mixing tank and fan. The water collecting trough 14 is disposed under the fuel cell main body 10 and the balance of plant 12 to collect overflow water from the fuel cell main body 10 and the balance of plant 12. In order to enhance function of water collection, an inclining flow passage 140 is provided at bottom of the water collecting trough 14. Further, at least a drain port 142 is disposed at the bottom of the water collecting trough 14 next to the low side of the inclining flow passage 140. The overflow water from the fuel cell main body 10 and the balance of plant 12 drops down to the high side of the inclining flow passage 140 and moves toward the low side of the inclining flow passage 140 such that the water can be collected at the low side of the inclining flow passage and flows outward via the drain port 142. The drained out water can be recycled to the balance of plant for further use.

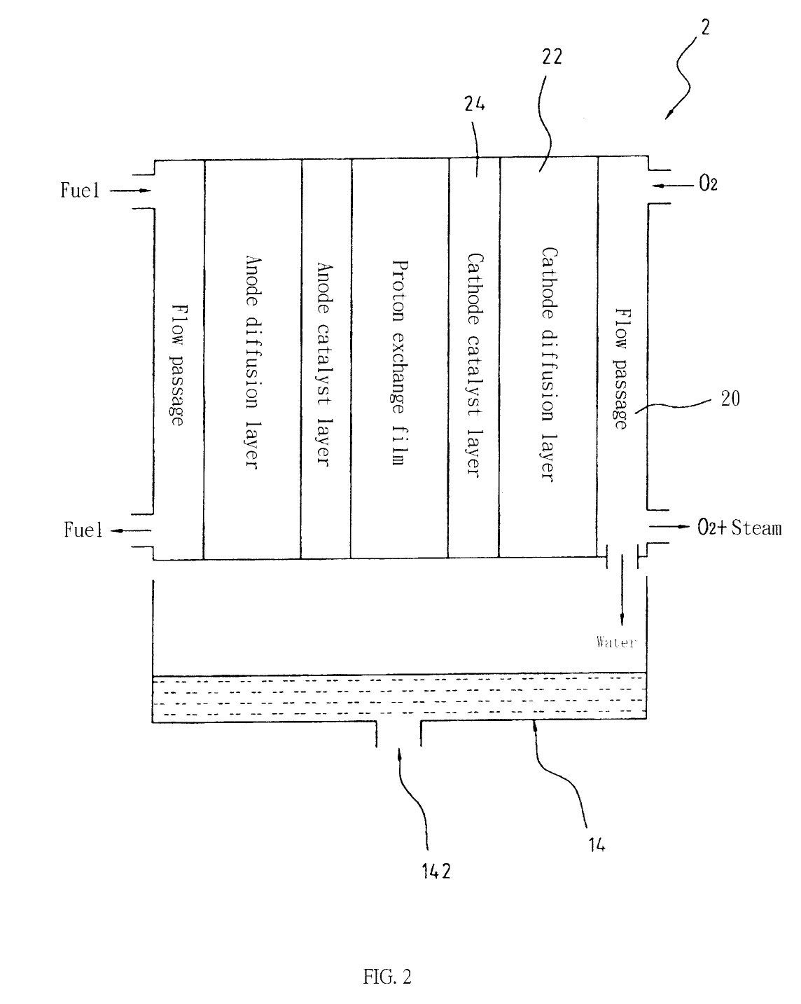

Referring to FIG. 2, a fuel cell unit 2 in the fuel cell main member 10 is illustrated to show the flooding and the produced water being collected with the water collecting trough. The fuel cell unit 2 includes an anode diffusion layer, an anode catalyst layer, a proton exchange film, a cathode catalyst layer and a cathode diffusion layer. When oxygen from a cathode flow passage 20 enters the cathode diffusion layer 22 to reach a cathode catalyst layer 24, electrons and hydrogen ions dissolved from oxygen and anode side perform electrochemical reaction to produce water and the cathode diffusion layer 22 discharges the produced water to avoid flooding. The water at the cathode flow passage 20 is probably either a state of steam or a state of water. The steam is discharged from the cathode flow passage 20 and sent to a condenser (not shown) in the balance of plant 12 and the water flows downward to the water collecting trough due to action of gravity. It is appreciated that the fuel cell device of the present invention is capable of recycling the water, which moves outward the drain port 142, in addition to the water being collected while the produced water usually is not treated in the prior art. This is one of advantages of the present invention.

Furthermore, the fuel cell device 1 can collect all the flooded water that is rapidly condensed with excellent condensation effect due to an aid of weather or ambient environment and is unable to be treated by both of the fuel cell main body 10 or the balance of plant 12 in time. Hence, it is not harmful to the entire fuel cell system and even to the electronic product containing the fuel cell system and the great deal amount of the condensed water can be reused to lessen dependence of water from external water supply source.

While the invention has been described with referencing to a preferred embodiment thereof, it is to be understood that modifications or variations may be easily made without departing from the spirit of this invention, which is defined by the appended claims.

What is claimed is:

1. A fuel cell device, comprising:
a fuel cell main body, being employed to generate power;
a balance of plant, being connected to the main fuel cell member; and
a water collecting trough, being disposed under the main fuel cell member and the peripheral equipment for collecting flooded water produced by the main fuel cell member and the peripheral equipment.

2. The fuel cell device as defined in claim 1, wherein the water collecting trough has an inclining passage with a high side and a low side at the bottom thereof.

3. The fuel cell device as defined in claim 2, wherein at least a drain port disposed at the bottom of the water collecting trough beside the inclining passage next to the low side.

4. The fuel cell device as defined in claim 1, wherein the balance of plant further comprises at least a pump, a condenser, a mixing tank and a fan.

5. The fuel cell device as defined in claim 1, wherein the fuel cell main body is a fuel cell stack.

6. The fuel cell device as defined in claim 1, wherein the fuel cell main body is a direct methanol fuel cell stack.
